(19) United States
(12) Patent Application Publication
(10) Pub. No.: US 2009/0302067 A1
(43) Pub. Date: Dec. 10, 2009

(54) DEVICE FOR METERED DISPENSING OF PASTY MASS, AND A CONTAINER THEREFOR

(76) Inventors: Bart Relinda Jan Hendrickx, Wilrijk (BE); Adriaan Van Der Wouden, Breda (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/089,594

(22) PCT Filed: Oct. 16, 2006
(86) PCT No.: PCT/NL06/00511

§ 371 Date: Oct. 16, 2008

(30) Foreign Application Priority Data
Oct. 10, 2005 (NL) 1030157

(51) Int. Cl. G01F 11/00; B67D 5/06

(52) U.S. Cl. 222/321.8; 222/181.3

(57) ABSTRACT

The invention relates to a device for metered dispensing of a pasty mass, such as viscous soap, comprising a housing provided with—connecting means for connecting the device to an opening of a container for pasty mass,—a dispensing chamber for the pasty mass,—a connecting channel which connects the connecting means to the dispensing chamber,—a first valve means which is arranged in the connecting channel and which closes feed from the connecting channel to the connecting means,—a delivery channel connected to the dispensing chamber for the purpose of delivering a dispensed quantity of pasty mass,—a displacing means which is movable in the dispensing chamber and which has a first position in which the dispensing chamber has a first volume and which is movable counter to a spring force of a spring means to a second position in which the dispensing chamber has a second, smaller volume,—a second valve means which is adapted to close the connection from the delivery channel to the dispensing chamber when the displacing means moves from the second position to the first position, wherein the second valve means comprises a movable body arranged around the displacing means.

The invention relates to a device for metered dispensing of a pasty mass, such as a viscous soap. The invention also relates to the use of a container filled with a pasty mass which can be connected to the device.

Such a device is known. A pasty mass such as a soap which is somewhat fluid is dispensed by the device through the operation of for instance a handle, whereby the pasty mass is released via the mouthpiece. The pasty mass is held in a container which is connected to the device from which a determined dosage is extracted during use.

Known dispensers with metered dispensing of soap are known from U.S. Pat. No. 2,774,517, GB 808,722 and NL-A-6413490. Use is made herein of valve means under bias.

A problem in the known devices is the complex assembly of the device through the use of different moving parts and/or valve means. The object of the invention is to provide a device for metered dispensing of a pasty mass which is assembled in simple manner. An object according to a second aspect of the invention is to provide a device which delivers the pasty mass without dripping occurring.

This object is achieved according to the invention by a device comprising a housing provided with connecting means for connecting the device to an opening of a container for pasty mass, a dispensing space for the pasty mass, a delivery channel connected to the dispensing space for the purpose of delivering a dispensed quantity of pasty mass, a connecting channel which connects the connecting means to the dispensing space, a first valve means which is arranged in the connecting channel and which closes feed to the connecting means, a displacing means which is movable in the dispensing space and which has a first position in which the dispensing space has a first volume and which is movable counter to a spring force of a spring means to a second position in which the dispensing space has a second, smaller volume, and a second valve means which is adapted to close the connection from the delivery channel to the dispensing space when the displacing means moves from the second position to the first position. The device according to the invention comprises a dispensing space for pasty mass. A filled dispensing space can be pumped empty with the displacing means. The pasty mass herein exits from the dispensing space to the outside via the delivery channel, while in flow-back direction the container is blocked by the first valve means. During the return stroke of the displacing means from the second position to the first position the connection between the delivery channel and the dispensing space is closed, whereby a pumping action is created. The volume of the dispensing space is enlarged, whereby the pasty mass is drawn out of the container through the connecting channel. According to the invention the second valve means co-acts with the movement of the displacing means. Such a device according to the invention is simple to assemble.

According to the invention the second valve means comprises a body arranged around the displacing means. This body will be set into motion by the movement between the strokes. The valve function can herein be made independent of the movement between the two positions. The operation by the person wishing to obtain soap is hereby used to adjust at least a part of the valve function. A particular valve function can hereby be obtained without a bias or other tension resulting from a spring means herein being necessary on a part of the second valve means. Use can particularly be made here of a body which, during at least one of the movements during the stroke, can move freely relative to the displacing means.

The body is preferably movable relative to the displacing means. The body is separate from the displacing means and can be placed in a different position relative to the displacing means, wherein the body has a first position relative to the displacing means, in which a passage is open between dispensing chamber and delivery channel, and a second position in which the passage is closed.

The body preferably comprises a flexible material. The body can co-act with a part of the displacing means in order to close the passage between dispensing chamber and delivery channel.

The body here preferably lies against a wall of the dispensing chamber. In a preferred embodiment the body clamps onto the dispensing chamber. The body will hereby be held in its position relative to the dispensing chamber when the displacing means is moved, while the body moves relative to the displacing means. With a continuing stroke of the displacing means the displacing means can function as carrier, and herein co-displace the body. During the stroke from the first to the second position or from the second to the first position of the displacing means the body, and therefore the second valve means, can hereby function as closing means for only a part of this stroke. The stroke from the second position to the first is particularly adapted to begin with an opened valve which is closed during the continuing stroke in that the body takes up its closing position relative to the displacing means and wall of the dispensing chamber.

In a preferred embodiment the delivery channel is arranged in the displacing means. The displacing means is provided with a recess through which the pasty mass can flow. The device according to the invention can hereby be assembled in efficient manner, since the displacing means and the delivery channel can be formed from one element. The two functions are performed by one member. The displacing means with delivery channel can be formed by injection moulding.

Preferably arranged close to the connection of the delivery channel to the dispensing space is a valve disc which protrudes substantially centrally in the dispensing space, and wherein the valve disc has at least one flange protruding in the direction of the side wall of the dispensing space. The pasty mass is hereby moved close to the outlet of the dispensing space around the valve disc toward the delivery channel, so that the pasty mass is set sufficiently into motion and cannot cake together.

The valve disc is preferably arranged on the displacing means. During movement of the displacing means through the dispensing space the pasty mass is hereby displaced by means of the valve disc, thereby generating sufficient flow in the dispensing space.

The second valve means is preferably formed by the valve disc and the body, which co-act with a wall of the dispensing chamber. The body is preferably a closing ring. The closing ring can close a passage from the dispensing space to the delivery channel formed between the flange of the valve disc and the side wall of the dispensing space. The valve operation is hereby obtained. The displacing means with the valve disc can be manufactured in efficient manner, for instance by injection moulding. Three functions are hereby fulfilled using one element which is manufactured by means of injection moulding.

The body, and preferably the closing ring, is preferably arranged lying freely around a part of the displacing means. The ring preferably has dimensions corresponding to the dimensions of the dispensing space in which the closing ring is arranged. The ring is for instance of rubber. Elastic material can easily be arranged around a narrower part which connects the displacing means to the valve disc. The ring is then arranged lying freely round a part of the displacing means. By making the ring a little larger than the dispensing space the ring will lie, and clamp to some extent, against the side walls of the dispensing space. The ring is hereby held in position.

The closing ring has three states. A valve function is obtained through co-action with the flange of the valve disc. A displacing means function is obtained through co-action with the displacing means. Between these the ring is in an intermediate phase wherein the displacing means body is displaced relative to the closing ring. This is during movement from the second position back to the first. The ring here creates a partial vacuum in the dispensing space, or at least an underpressure is created, thereby preventing droplet formation at/in the delivery channel.

Droplet formation can be further countered by arranging a venturi close to the dispensing opening. This can be a separate attachment arranged partially in the opening close to the outer end. The above described action of the underpressure in the intermediate phase will be reinforced by the narrowing of the delivery channel. The narrowing, in co-action with the viscosity of the fluid, will also serve to slow the movement of this liquid.

The dispensing space is preferably cylindrical. The displacing means preferably has the same cylindrical form. The displacing means has a diameter which is a little smaller than the diameter of the cavity of the dispensing space.

A groove can optionally be arranged around the displacing means, in which groove can be arranged a second O-ring which connects closely to the side walls of the dispensing space.

The radius of the dispensing space and the radius of the delivery channel are closely related to each other and depend on the viscosity of the pasty mass. There is a relation between the viscosity and the diameter of the delivery channel. If the delivery channel is too narrow, the pasty mass will remain behind in the delivery channel and begin to coagulate, while if the delivery channel is too large the pasty mass will be able to drip out of the device.

A preferred embodiment of the device is provided with adjusting means for the dispensing. The adjusting means determine a difference in the volume in the first and second position of the displacing means. The adjusting means influence the extreme positions. In one embodiment the adjusting means is formed by a stroke limitation of the displacing means and/or parts coupled thereto.

In a possible embodiment the adjusting means are formed by the valve disc. The valve disc protrudes from the displacing means into the dispensing space. As the part protruding furthest from the displacing means, the valve disc will be the first to lie against the opposite part of the dispensing space, preferably a side wall of the dispensing space on which the connecting channel debouches. An increase in the distance between the valve disc and the displacing means will result in a reduction of the stroke. The displacing means can for instance be connected by a screw thread to the valve disc. The displacing means and the valve disc then consist of two separate parts. The distance between valve disc and displacing means can be adjusted with the screw thread.

According to another option, a suitable length can be given to one or more protrusions arranged along the periphery of the displacing means, wherein associated stops are provided for these protrusions. This embodiment is advantageous because a number of displacing means with protrusions having a different length can be provided in simple manner without the other components of the device having to be modified. A displacing means can thus be provided for instance which is suitable for soap, and another which is suitable for a hand cream, these products typically requiring a different dosage.

In accordance with yet another option, different stop means can be provided, such as for instance a cylindrical neck with grooves of a determined length. These can then be utilized in accordance with the desired dosage.

A handle is preferably connected by means of a hinge to the housing. The handle is also coupled to the displacing means. The stroke movement of the displacing means can hereby be operated with the handle.

According to a first option, the first valve means is formed by a ball which is arranged in the connecting channel and which closes a passage through the connecting channel with a bias in the direction of the connecting means. The ball is biased in order to close the connecting channel. The bias is directed toward the connecting means. A predetermined force can however be overcome, for instance by pump action of the displacing means. The closing of the second valve means causes an underpressure in the dispensing space which is sufficient to open the passage through the connecting channel. Pasty mass will hereby be able to flow from the container to the dispensing space.

The flow of pasty mass from the dispensing space to the container is however blocked because the ball lies against a wall of the connecting channel and completely closes this passage. A pumping action in the direction of the container will not open this valve. Such a valve means has surprisingly been found to work well. The embodiment is exceptionally simple. Costs can be kept low.

A spring preferably engages on the ball with a determined bias. This is also a cost-effective embodiment.

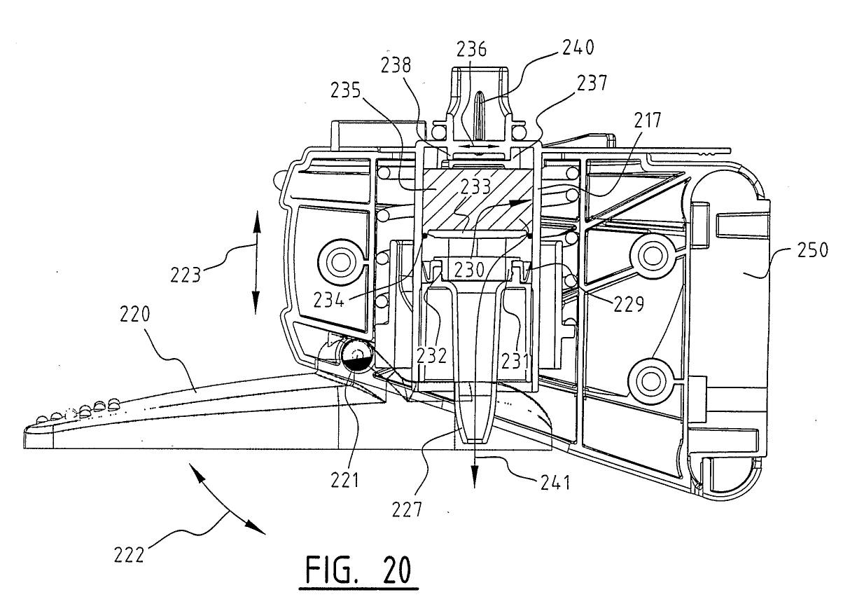

According to another option, the first valve means is a flat valve as shown in FIGS. 19 and 20.

The device preferably also comprises the container. The container has a receiving space for the pasty mass. A piston is movable in the receiving space. The pasty mass is hereby scraped from the side walls of the container/receiving space when the container is emptied. The piston ensures that substantially all pasty mass present in the receiving space will arrive at an opening of the container, and can be there discharged, for instance via the connecting means of the device according to the invention. The piston is arranged in usual manner for movement in the receiving space of the container and connects to the side walls thereof. The piston and the receiving space are preferably given a cylindrical form.

The container is preferably a can. The can has an opening. A disc preferably protrudes from the housing into the opening of the engaged container, preferably the can. The disc forms an obstacle to the flow of the pasty mass. The mass will have to flow round the disc. The disc preferably protrudes in a central part of the container. The pasty mass will flow round the disc, in particular along the side walls, thereby ensuring that the pasty mass does not cake together along the side walls. It is noted that according to the prior art a problem occurred in the emptying of containers. Residues of pasty material remained behind in the container in a funnel of V-shaped cross-section directed toward the opening of the container. The disc preferably comprises a flange which protrudes in the direction of a side wall of the container.

The disc is preferably a diaphragm. The radius of the diaphragm is adjustable. The housing provided with the diaphragm can thus be connected to different containers of differing dimensions. The diaphragm is adjustable to the size of the opening of the container.

The device is preferably provided with engaging means for attaching a device to a fixed object. The device is preferably adapted to be oriented with the container on a top side, the delivery channel on a bottom side and the dispensing space therebetween. Use is made here of the force of gravity which urges the pasty mass in the direction of the delivery channel.

Wall projections can be arranged in the delivery channel. The wall projections extend in the lengthwise direction of the channel. The wall surface of the delivery channel can also be enlarged in other manner. Owing to the surface area enlarging means a fluid for dispensing will adhere more to the walls, and droplet formation is less likely to occur.

The invention also relates to a container suitable for application with a device according to the invention. Such a container is for instance provided with an opening through which the diaphragm of the device can be placed.

Engaging means are preferably arranged on the device or on the container for engaging respectively the container or the device according to the invention. The two parts can hereby be coupled to each other. The container is releasable and can be replaced. An empty container can be exchanged for a full one. The dispensing device according to the invention can be used for different containers. The engaging means preferably comprise a screw connection. The coupling can be further guaranteed by arranging elastic rings which make a sealing closure.

The invention will be further described with reference to the accompanying drawings, in which:

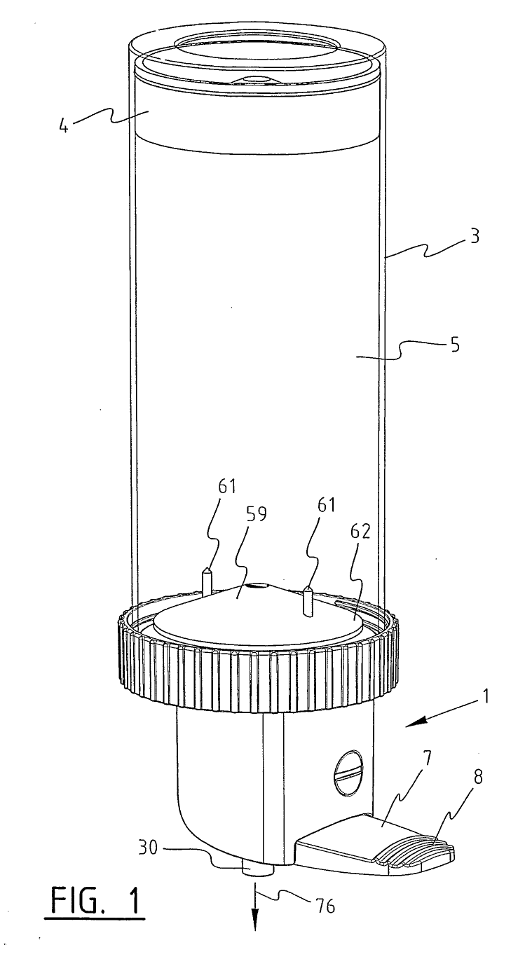

FIG. 1 is a perspective view of the device according to the invention in a first embodiment provided with a container,

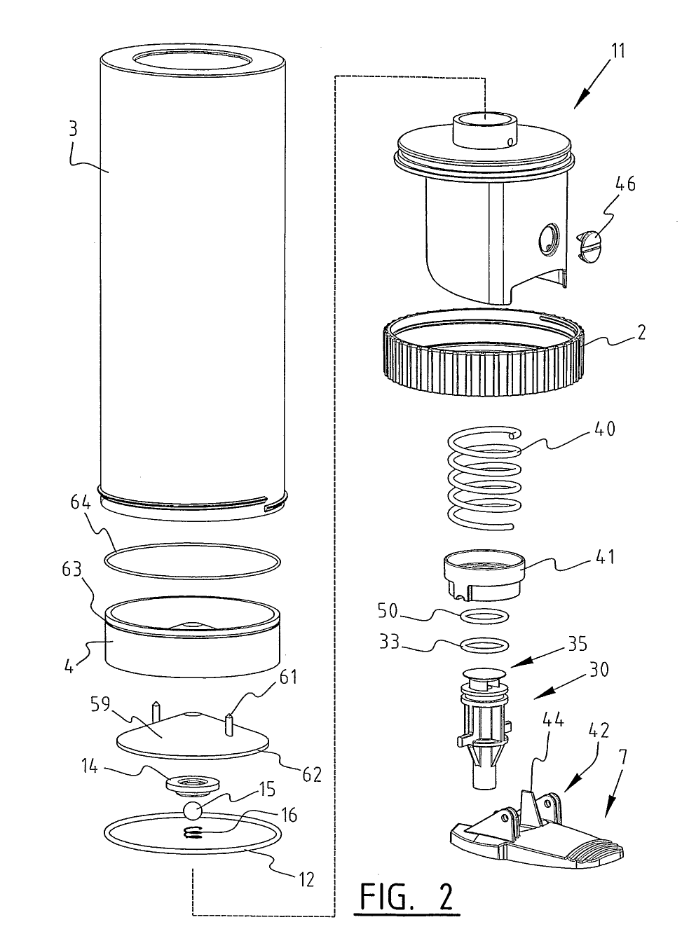

FIG. 2 is a perspective view of the assembly of a device according to the invention,

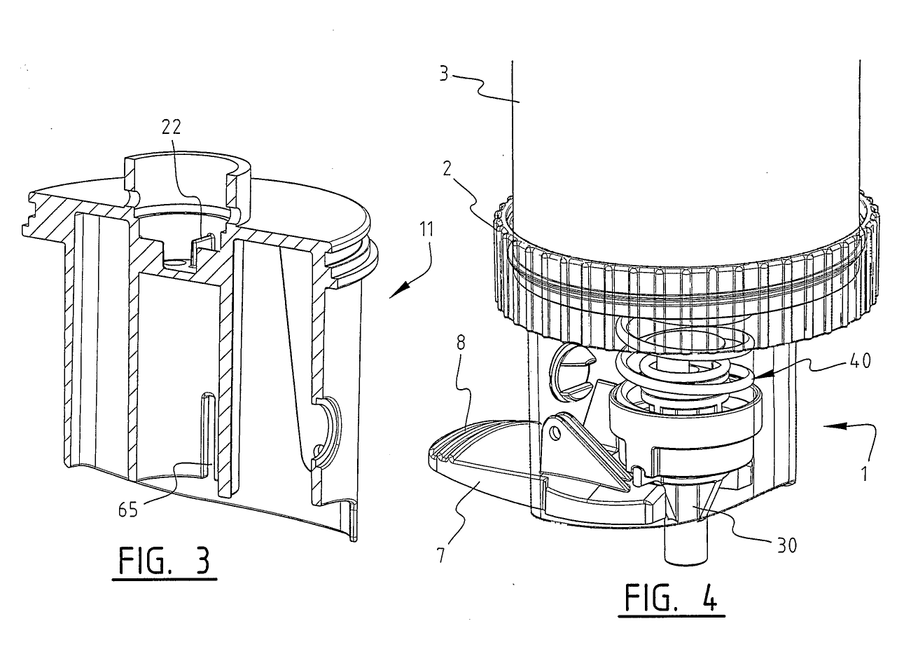

FIG. 3 is a perspective view of a cross-section of the housing of a device according to the invention,

FIG. 4 is a perspective view of the device according to the first embodiment, wherein the housing is not shown,

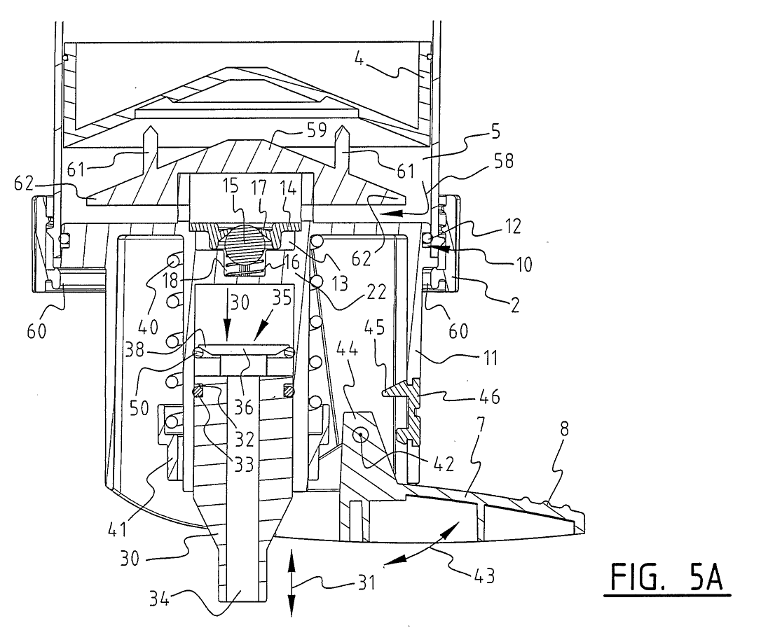

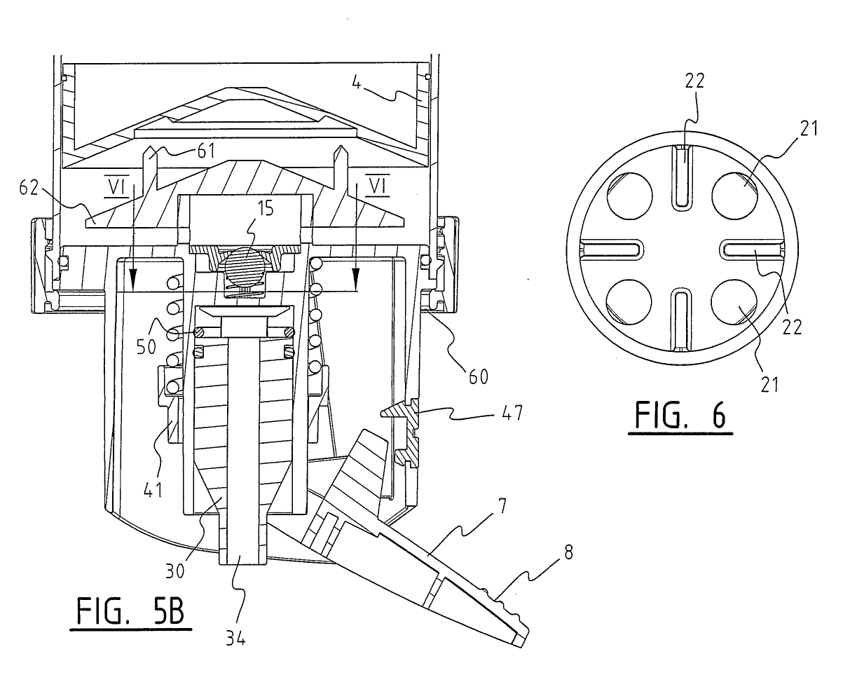

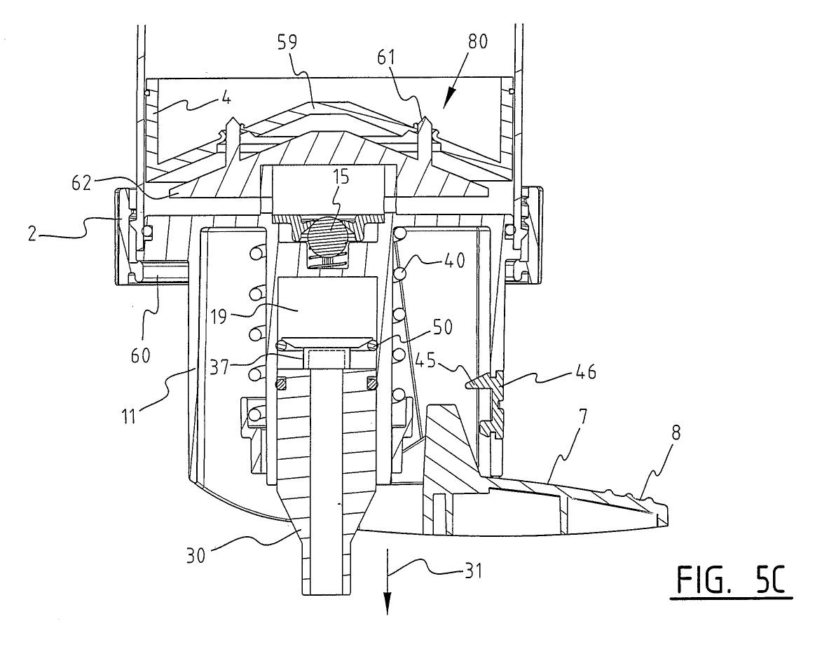

FIGS. 5a-5c show sections of the device in which three steps are shown for metered dispensing of pasty mass,

FIG. 6 shows a section along the line VI-VI in FIG. 5b,

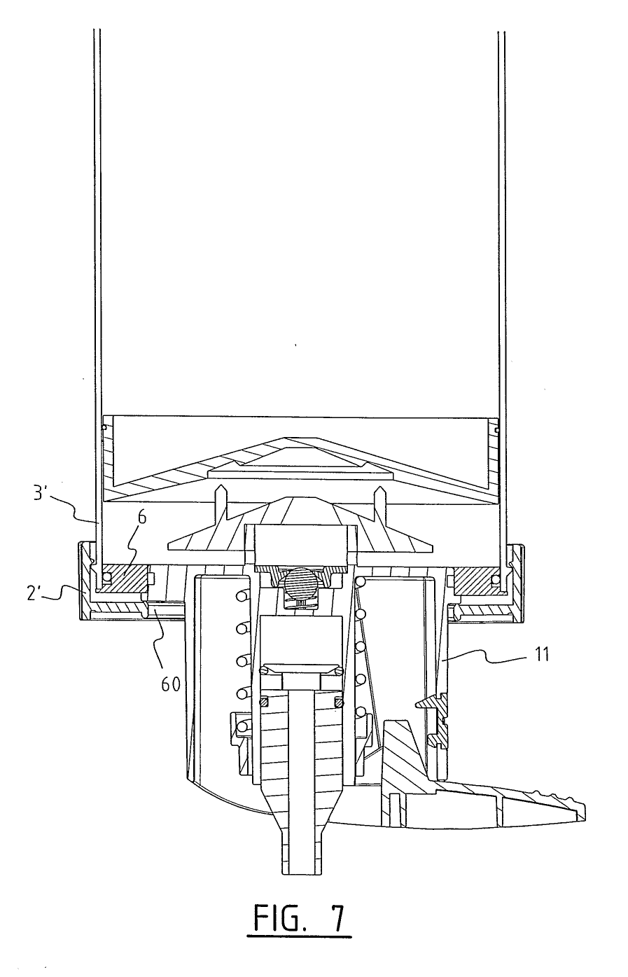

FIG. 7 shows a section of an alternative embodiment of the device according to the invention,

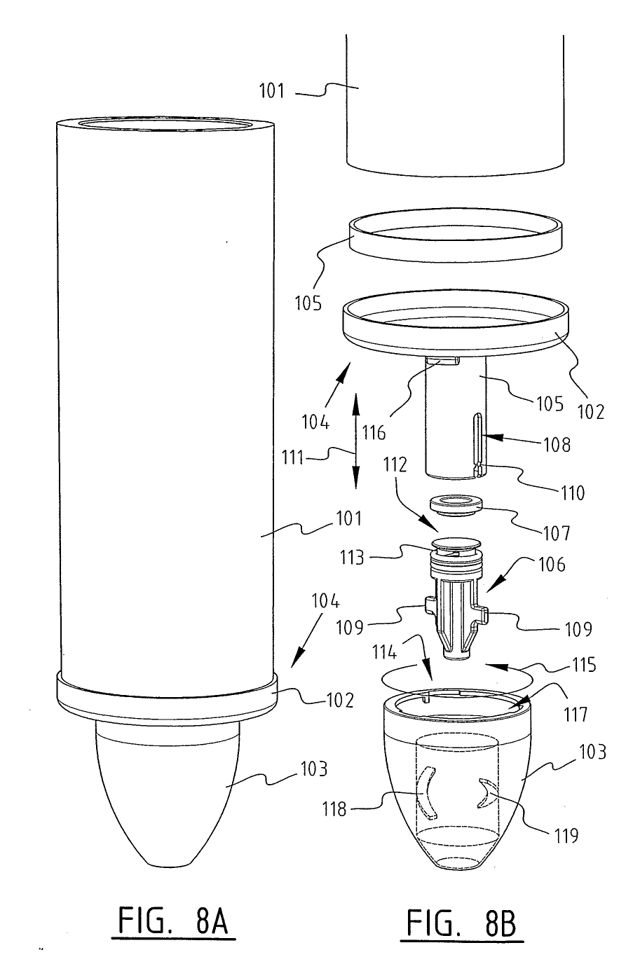

FIG. 8a shows a perspective view of a third embodiment of the device according to the invention,

FIG. 8b shows a perspective view of the assembly of a third embodiment of the device according to the invention,

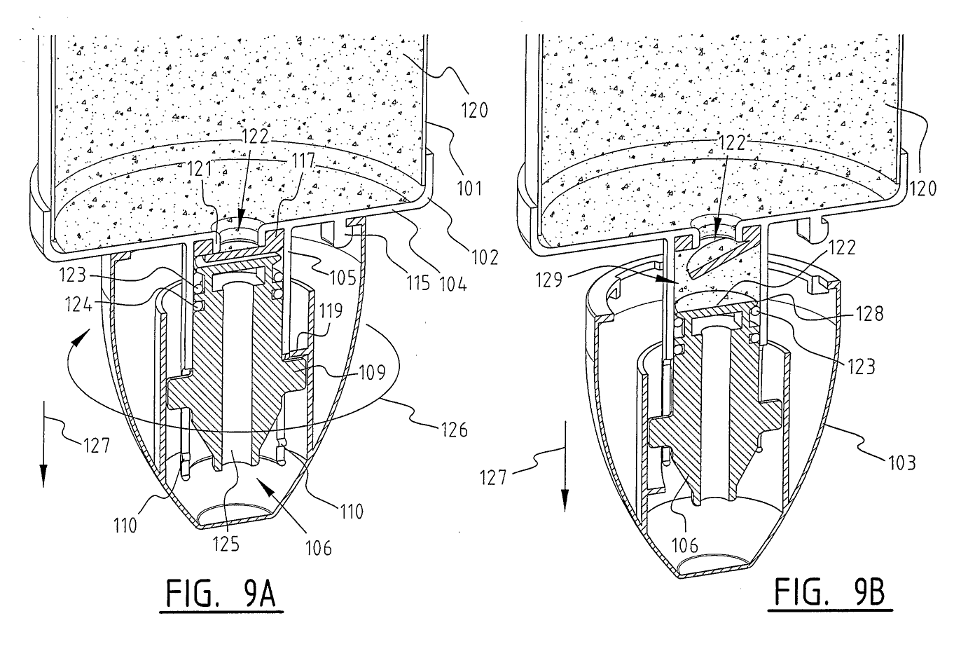

FIG. 9a shows a detail of the third embodiment of the device according to the invention,

FIG. 9b shows a detail of the third embodiment of the device according to the invention,

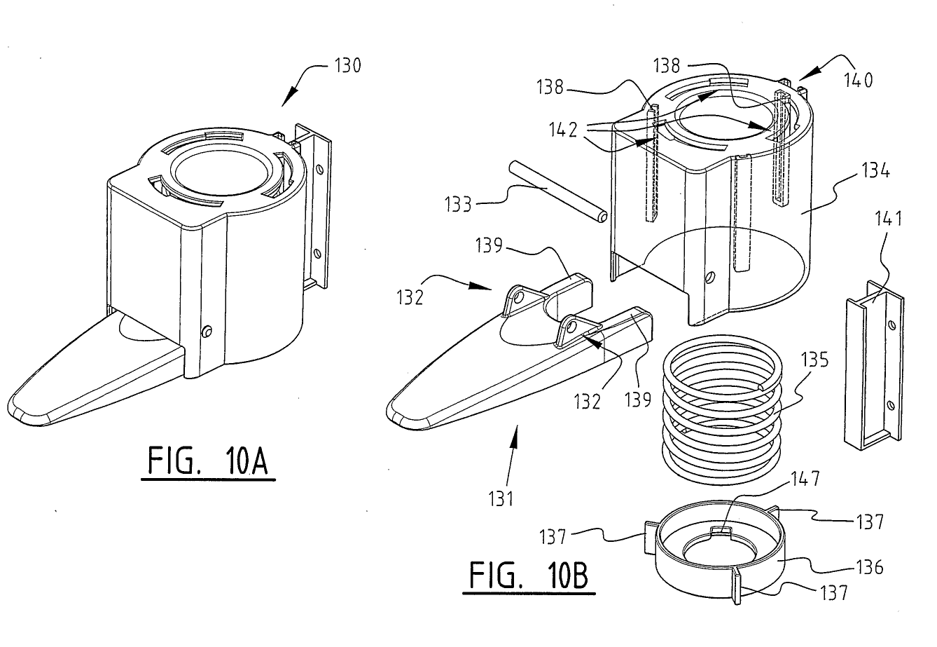

FIG. 10a shows a detail of the third embodiment of the device according to the invention,

FIG. 10b shows a perspective view of the assembly of a detail of the third embodiment of the device according to the invention,

FIG. 11 shows the manufacture of the third embodiment of the device according to the invention,

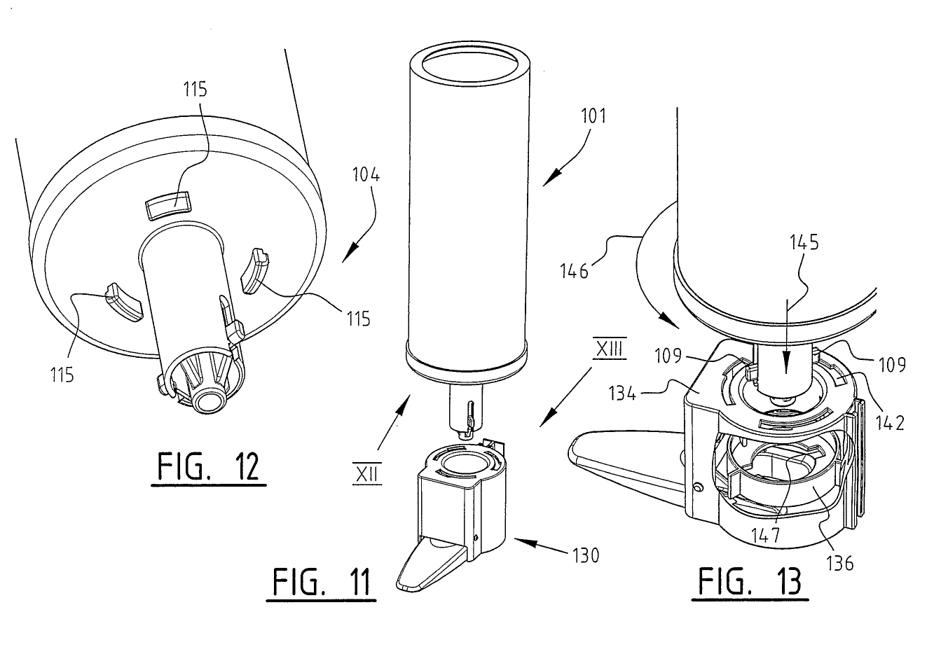

FIG. 12 shows a detail along arrow XII in FIG. 11,

FIG. 13 shows a detail along arrow XIII in FIG. 11,

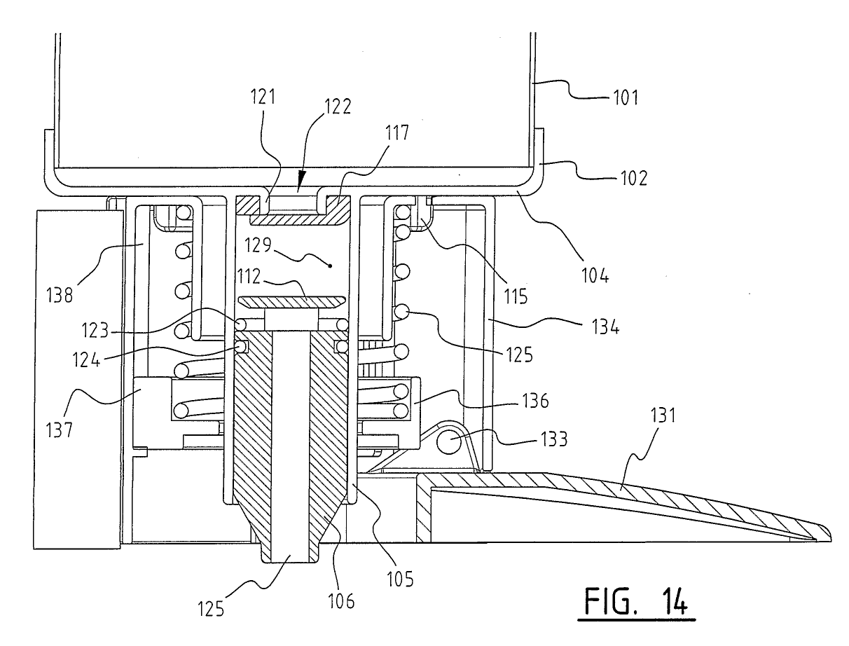

FIG. 14 shows a cross-section of the assembled third embodiment of the device according to the invention,

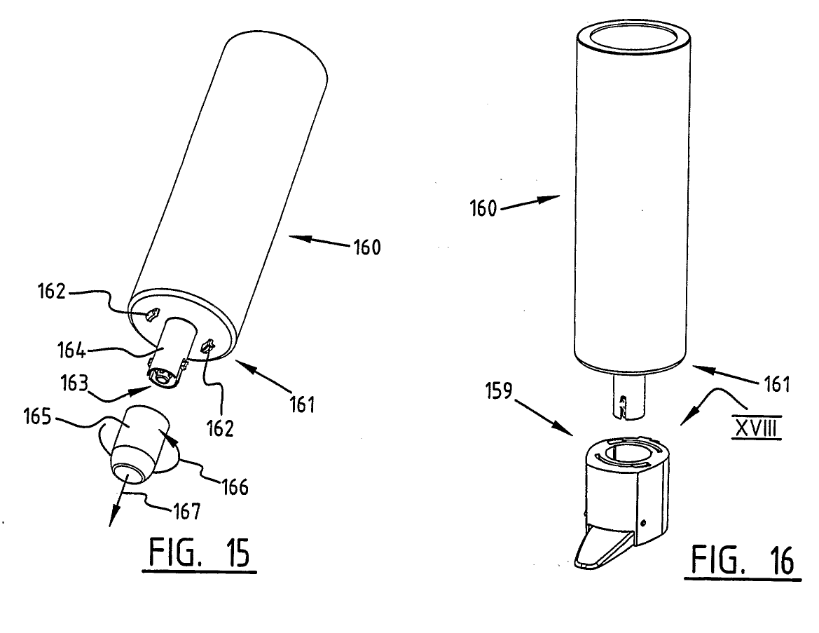

FIG. 15 shows a perspective view of a fourth embodiment of a component of the dispensing device according to the invention,

FIG. 16 is a perspective view of a fourth embodiment of an assembly of the dispensing device according to the invention,

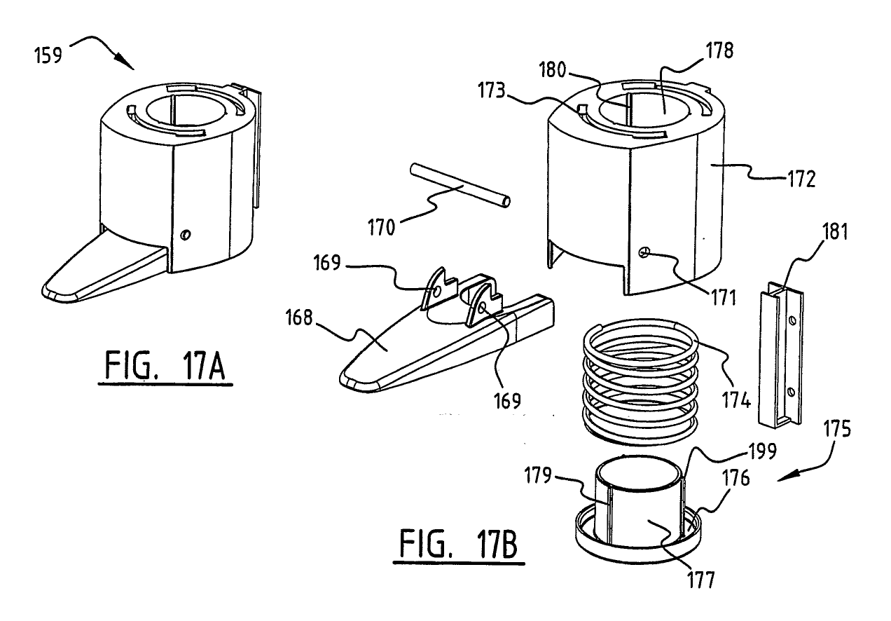

FIGS. 17a-17b show the pump unit according to the fourth embodiment,

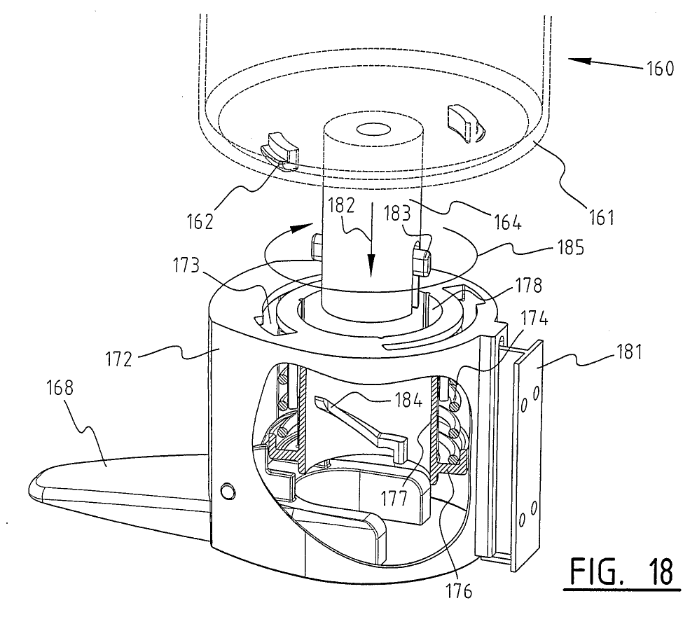

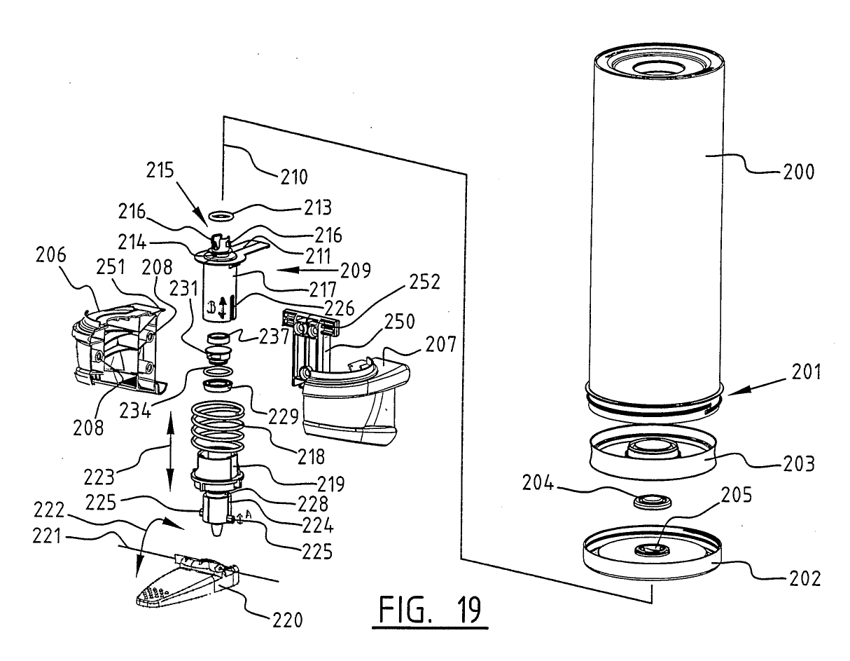

FIG. 18 shows a partially cut-away perspective view according to arrow XVIII in FIG. 16 of the fourth embodiment,

FIGS. 19-20 show views of a fifth embodiment.

FIG. 1 shows a device 1 for dispensing pasty mass. Device 1 is coupled via a ring 2 to a container 3 (broken lines) which is shown cut-away. Container 3 is cylindrical. A piston 4 is arranged in an upper part of container 3. The piston is movable through the receiving space 5 of container 3. Piston 4 scrapes the residues of the pasty filling of receiving space 5 from the side walls of container 3. Due to underpressure caused by mass being suctioned away under piston 4, the piston is drawn downward via device 1.

Container 3 is provided close to the end remote from piston 4 with a screw thread on which the ring 2 provided with a screw thread can engage. Ring 2 can couple container 3 to device 1. The outer end remote from piston 4 is the outlet side of container 3. The container is provided there with an opening. In this embodiment the container is wholly open on this side. The pasty mass received in receiving space of container 3 can leave container 3 on this side.

Ring 2 engages on device 1 via an adjusting ring 60 (FIGS. 5a-5c). The size of ring 2 depends on the size of container 3. Adjusting ring 60 couples ring 2 to device 1. Different dimensions of adjusting ring 60 enable couplings to different containers 3.

Using fastening means the device 1 can be fastened to a wall in a vertical position as shown in FIG. 1, with container 3 above device 1.

The open side of container 3 is connected to device 1. Pasty mass can be received in device 1 via an opening 6 on the top side of device 1, which is shown in more detail in FIGS. 5a-5c. The connecting channel of device 1 starts at the opening 6.

FIG. 1 also shows a disc 59 provided with upward protruding tips 61. The disc is provided with flanges 62 protruding in the direction of the side walls of container 3. The disc and the flanges urge the pasty mass to flow along the side walls. Such a flow reduces the residues left in the container during emptying thereof via a device as shown in the figure.

In a preferred embodiment disc 59 is a diaphragm, the radius of which can be adapted to the size of the opening of container 3. The flow of the pasty mass, indicated in FIG. 5a with reference 58, is modified such that it takes place sufficiently along the side wall of the container.

Tips 61, see FIG. 5a, pierce piston 4 when the container is almost empty. Reuse of the container is hereby prevented.

Device 1 is provided with a handle 7 provided with a portion with ribs 8. The user operates device 1 by pressing on portion 8 of handle 7 in the direction according to arrow 9, wherein pasty mass is released in a direction 71 via the delivery channel in displacing means 30. Through the action of a spring 40 (shown in FIGS. 2 and 5a-5c) handle 7 moves back after use to the position shown in FIG. 1.

FIG. 2 shows how a device 1 can be assembled. The different components will be described with reference to FIGS. 5a-5c.

Piston 4 is provided with a groove 63. A ring 64 can be received therein so that the piston fits closely against the inner wall of the container.

FIG. 3 shows a cross-section of housing 11 of device 1. The part can be formed from a plastic, for instance by injection moulding. Visible are the flanges 22, which will be described with reference to FIGS. 5a-5c. Also visible is slot 65.

FIG. 4 shows device 1. The fork shape of handle 7 which engages on the “spout” of displacing means 30 can be seen.

FIG. 5a shows in cross-section the device 1 and a part of container 3. The same numerals refer to the same parts as in FIG. 1.

The open end of the container/tube 3 is received in ring 2 which is in turn connected to device 1. Arranged in a groove 10 of housing 11 is a ring 12 of elastic material, such as rubber, which fits closely against the inner wall of receiving space 5 of container 3. A seal is thus obtained where device 1 connects to container 3. Ring 2, ring 12 form part of the connecting means of the device according to the invention. With the connecting means a container 3 can be coupled to device 1. In another embodiment of the invention the delivery device/dispensing part 1 and the container with soap 3 are formed integrally. The dispensing part is not then reusable.

In this embodiment opening 6 is formed by a closing cover 14 arranged in a recess 13 of housing 11, wherein a ball 15 is pressed by means of a spring 16 against flanges 17 of this cover. A valve means is thus obtained which is arranged in connecting channel 18 situated between the receiving space 5 for pasty mass and the dispensing space 19 of device 1. The valve means is formed such that connecting channel 18 will be closed in a rest position.

By creating an underpressure in dispensing space 19 the ball will move toward dispensing space 19 as according to arrow 20, and pasty mass can flow out of receiving space 5 via the passage between flanges 17 into connecting channel 18 and finally dispensing space 19.

Arranged in housing 11, as shown in FIG. 6, are openings 21 via which the pasty mass can flow to dispensing space 19. Openings 21 form part of connecting channel 18.

Ball 15 is held centrally in the connecting channel by means of the four ribs 22 which are shown in FIG. 3 as well as in FIG. 6.

Dispensing space 19 is formed cylindrically in housing 11. A displacing means or plunger 30 can be received in dispensing space 19 and is movable in the dispensing space as according to arrow 31. Displacing means 30 is provided with a groove 32 in which a ring 33 of elastic material is received such that a seal is obtained between dispensing space 19 and the open end.

Displacing means 30 is provided with a delivery channel 34 which is arranged centrally in the displacing means and which forms an open connection from dispensing space 19 to the outside. Pasty mass can be dispensed in dosages via the delivery channel. The diameter of delivery channel 34 depends on the viscosity of the pasty mass. When a pasty mass is viscous, a greater diameter will be necessary.

Displacing means 30 is also provided with a part 35 of T-shaped cross-section protruding into dispensing space 19. This part is also shown in FIG. 2. Displacing means 30 can be formed integrally with T-shaped part 35 by injection moulding.

The part is arranged as a kind of cover over the entrance to delivery channel 34. The channel remains accessible from dispensing space 19 because disc 36 is placed on legs 37 arranged around the mouth of delivery channel 34.

Valve disc 36 is circular and provided with flanges 38 protruding toward the side walls of dispensing space 19. The part 35 of T-shaped cross-section is arranged in the central part of dispensing space 19. Flanges 38 run obliquely on an underside thereof. During an upward stroke of displacing means 30 in the direction of connecting channel 18 as according to arrow 31, valve ring 36 will move through dispensing space 19, and the pasty mass present there will flow around flanges 38 along the side walls of dispensing space 19 to the opening of delivery channel 34, and through this to the outside.

A spring 40 is arranged around the housing parts of dispensing space 19. The spring lies against a top side of the housing and on a spring-loaded bush 41 close to the underside. The spring bush 41 is connected to displacing means 30. The connection is not shown in FIG. 5a. A slot 65 is arranged in housing 11 in longitudinal direction of dispensing space 19 so that the spring bush 41 can be connected to displacing means 30. Both parts will move upward as according to arrow 31 during a stroke with handle 7.

Handle 7 has the form of fork at one outer end. This outer end engages on displacing means 30 and spring bush 41. One of the two parts is engaged with the fork shape. Handle 7 pivots about hinge 42, formed in the usual manner by for instance a bearing. A movement as according to arrow 43 hereby becomes possible when a user presses on ribbed portion 8. Displacing means 30 and spring bush 41 are herein moved upward as according to arrow 31 and dispensing space 19 is decreased in size. This is shown in FIG. 5b. Spring 40 is compressed. Valve ring 36 herein runs up against the underside of connecting channel 18. This is a second position according to the invention. FIG. 5a shows a first position according to the invention.

Handle 7 is provided with a protrusion 44 which, during operation, can run up against a stop 45 of an adjusting means 46 arranged in housing 11 of device 1. In the situation shown in FIGS. 5a and 5b the stop 45 is however rotated away and protrusion 44 can move freely. Adjusting means 46 is arranged in a housing 11 and can be rotated. When adjusting means 46 is rotated 180°, protrusion 44 will run up against stop 45 and will not be able to move as far as shown in FIG. 5b. An adjustment of the dosage is hereby obtained. The dosage will after all depend on the difference in volume in dispensing space 19 between the first situation as shown in FIG. 5a and the situation as shown in FIG. 5b.

As stated, FIG. 5b shows that the situation in the second position of device 1. Via spring bush 41 the spring 40 will want to push displacing means 30 back into the first position as according to FIG. 5a. During operation of handle 7 this spring force must be overcome by the user. During the movement stroke from FIG. 5a to FIG. 5b the passage of dispensing space 19 to the outside via delivery channel 14 is open. The pasty mass can move along flanges 38 of valve ring 36 and through the opening under valve ring 36 into delivery channel 34. The movement of flanges 38 along the side walls of dispensing space 19 provides for a flow of pasty mass in the whole dispensing space 19, thereby preventing caking together of pasty mass along the side walls.

During the movement stroke from FIG. 5a to FIG. 5b the first valve means formed by ball 15 and spring 16 is not opened. The pressure generated in dispensing space 19 will only push the balls 15 more against their seat formed by flange 17 of closure 14.

FIGS. 5a and 5b show a ring 50 in cross-section. The ring is arranged around the narrower part of displacing means 30 and the part 35 of T-shaped cross-section. The ring lies free. The ring has a diameter substantially equal to the diameter of receiving space 19.

FIG. 5c shows the return stroke of displacing means 30 when handle 7 is released by the user. During the return stroke the free-lying ring 50 will move under flange 38, thereby creating a closure.

Piston 4 is moved slightly downward relative to the position in FIG. 5a. The tips 61 protruding upward from disc 59 then pierce a number of weak portions arranged in piston 4.

The part 35 of T-shaped cross-section with flanges 38 together with the free-lying ring 50 together form a second valve means in this embodiment. Due to the second valve means an underpressure will be created in dispensing space 19, while the volume of this space will increase during this return stroke. The underpressure is large enough to overcome the bias of spring 16 on ball 15 and to allow release of the ball from its seat 17. The underpressure created in dispensing space 19 ensures that pasty mass can flow out of receiving space 5 via connecting channel 18 and the opening 6 left clear by ball 15. Piston 4 will herein be moved slightly downward by the underpressure in receiving space 5 (FIG. 1). Receiving space 19 is filled with the pasty mass and device 1 will arrive in the situation shown in FIG. 2a. The position of the free-lying ring 50 can vary.

The device according to the invention comprises a displacing means 30 which is also provided with delivery channel 34 and components of the second valve means. Device 1 and displacing means 30 can be assembled by injection moulding.

In another embodiment cover 14 can be co-moulded with housing 11.

FIG. 7 shows an embodiment with an alternative ring 2′ which engages on a peripheral protrusion arranged on and around the outside close to the outer end of container 3′.

Other embodiments are possible without departing from the essence of the invention stated by the appended claims.

FIG. 8a shows a fluid dispensing device such as a soap dispenser, comprising a container 101 provided on one outer end with a ring 102 and a cap 103. Soap is arranged in container 101. The soap is dispensed via the outer end close to ring 102. The soap can be held in the container in a bag, or the container can be provided with means as according to FIGS. 1-7.

Container 101 is a cylinder in cross-section and comprises an open end where ring 102 is arranged. Ring 102 has a diameter such that it can be arranged round the cylindrical outer end of container 101, optionally supplemented by means of closing ring 105. Ring 102 is part of a funnel-like component 104 provided with a spout 105. Spout 105 is cylindrical and hollow and forms the receiving space for plunger 106 as well as valve 107. Spout 105 is provided with two longitudinal slots 108 in which the arms 109 of plunger 106 can be received. Protrusions 110 are arranged at one outer end of slot 108. The plunger with arms 109 which are received in slot 108 thus has limited movement. The plunger is movable as according to arrow 111 in slot 108 between two extremes positions. These extreme positions will be shown further in subsequent figures.

Plunger 106 is of a design similar to the plungers of the first embodiment. On one outer end of the plunger is a table-like part 112 which has a diameter smaller than the diameter of the cavity in spout 105. Fluid can flow through between the hollow side walls and table 112. An O-ring 113 is arranged under table part 112 and provides a second valve function. When the plunger moves upward as according to arrow 111, the O-ring will take up position as shown in FIG. 8b, while during the downward movement of plunger 106 as according to arrow 111 the O-ring will lie against the edge of table 112, whereby no fluid can flow between the edge of table 112 and the side wall of the hollow space of spout 105. This connection is then closed.

Plunger 106 is provided with a channel running through the body of the plunger from the area below table 112 as far as the outer end of the plunger.

Said components 101, 102, 104-113 can be assembled so that container 101 is obtained provided with the dispensing device on one outer end.

The assembled outer end is covered with a cap 103. Cap 103 is partially hollow and is shown partially cut-away in FIG. 8b. Spout 105 with plunger 106 can be received in the hollow space 114. After assembly the plunger is positioned in the upper part of spout 105 so that arms 109 lie against the upper end of slot 108. As shown in FIG. 9a, there is then no fluid in the region between valve 107 and plunger 106.

Cap 103 is arranged by being moved as according to arrow 115, i.e. by being rotated around the longitudinal axis, whereby three protrusions 116 (only one of which is shown) are received in recesses 117 close to the mouth of cap 103 and are tightened. This is a bayonet fitting.

Hollow space 114 of cap 103 is provided with two wings 118,119 which are arranged around the side wall of hollow space 114 and which serve as guide for arms 109.

FIG. 9a shows a cross-section of the assembled cap with container. Container 101 is filled with a fluid. Valve 117 is arranged around flange 121 of mouth 122 which forms an open passage in funnel-like part 104. Also shown are two O-rings 123,124 which are arranged round a portion of plunger 106. Plunger 106 is provided with a channel 125 in lengthwise direction. Arms 109 are received in slot 108 and are located in an extreme position. Arms 109 lie against the wing-shaped guides 118 and 119.

When cap 103 is removed, wherein it must be loosened as according to arrow 126, wings 118, 119 will engage on arms 109 of plunger 106, whereby this latter moves downward as according to arrow 127 into the hollow space of spout 105 until arms 109 run up against protrusions 110. Movement herein takes place to the position shown in FIG. 9b. During the downward movement valve 117 will open, whereby fluid such as soap will flow into spout 105 through the non-closed mouth 122. Owing to the downward movement of plunger 106 the ring 123 lying clampingly against the inner wall of channel 125 will come to lie under flange 128 of table 112, whereby a suction action occurs which will cause the hollow space 129 created between table 112 and mouth 122 to be filled with medium 120. After removal of cap 103 the container provided with dispensing ends is ready for use.

FIG. 10a shows a pump unit of the fluid dispenser. Together with the container and dispensing unit, this forms a system for the fluid dispensing device. Pump unit 130 is formed by a handle 131 provided with eyes 132 which can accommodate a shaft 133 such that handle 131 can be connected pivotally to body 134. All components can be formed by means of injection moulding. Pump unit 130 further comprises a spring 135 and a closing ring 136. Spring 135 and closing ring 136 are accommodated in body 134, wherein ring 136 is arranged with arms 137 in slots 138 in body 134. Closing ring 136 can thus move vertically in body 134, guided by slots 138. The movement of closing ring 136 is limited by the grooves being closed on both sides. Handle 131 engages with two arms 139 on closing ring 136. Arranged on the outer side of body 134 is a groove 140 in which a profile part of I-shaped cross-section 141 can be arranged for fixing of pump part 130 to a fixed entity such as a wall. Pump unit 130 is a reusable device which does not come into contact with the fluid that is dispensed. Pump unit 130 need not therefore be cleaned during mounting or release of the container with fluid such as soap. Body 134 is provided with three receiving grooves 142 in which protrusions 115 of closing ring 104 can be received and secured by means of rotation. This is also a bayonet fitting.

FIG. 11 shows placing of the container/dispensing part 101 on pump part 130. The three protrusions 115 protruding from the funnel-like mouthpiece are shown in FIG. 12, this figure showing a view along XII in FIG. 11. Protrusions 115 are placed in receiving grooves 142 of pump unit 130 as according to arrow 145 in FIG. 13, wherein protrusions 115 engage under the material of the top side of body 134 through rotation of the container as according to arrow 146.

When part 101 is carried downward as according to arrow 145, arms 109 of plunger 106 will be received in recess 147 of closing ring 136. Receiving openings 147 are arranged diametrically relative to each other around a central cylindrical opening. When device 101 is rotated as according to arrow 146, arms 109 will move under the material of closing ring 136. When closing ring 136 is moved upward because arms 109 exert upward pressure on this ring, the resilience of spring 135 will want to return closing ring 136 to its starting position as shown in FIG. 13. The starting position in FIG. 13 is the position where closing ring 136 lies with arms 137 at the lowest position in slots 138 on the inner side of body 134.

This position is further shown in cross-section in FIG. 14. The same parts are designated here with the same reference numerals. The operation of the assembled dispensing device of FIG. 14 according to a second embodiment is the same as the operation of the first embodiment.

One of the advantages of the second embodiment is that an assembly is obtained wherein a first unit (container+dispensing device covered with cap) forms the replaceable part of the assembly, this part being in contact with the fluid that is dispensed. The second part (pump part) receives the portion of the first part and operates without coming into contact with the residual fluid. A device is obtained here which is simple to keep clean. Because operation takes place with the dispensing system according to the invention, which is simple to assemble from a number of components which can be manufactured at low cost, it is possible to achieve this separation. An empty container including mouthpiece 104 and plunger 106 can be discarded and replaced. The empty first parts can optionally be collected and reused. Because the second part does not come into contact with the fluid, this second part is not affected by aggressive chemical fluids, and this part can be reused for a long time. Determined soaps can also adversely affect the structure of the dispensing device. The parts which can be affected are replaced in this embodiment.

FIG. 15 shows a perspective view of a container 160 according to a fourth embodiment in which a fluid can be received. The container is a cylinder sealed at one outer end with a mouthpiece 161 substantially the same as in the third embodiment. This mouthpiece is provided with two protrusions 162 which can form a bayonet closure with a pump part 159. The container provided with mouthpiece 161 is the component of the dispensing device which can be replaced each time. Plunger 163 is received in spout 164 and is covered with a cap 165 which can be removed from mouthpiece 161 by means of a turning and pulling movement (166,167). Cap 165 according to the fourth embodiment is a simple break-off cap or screw cap.

FIG. 16 shows how cylinder 160 is placed with mouthpiece 161 on pump part 159. This pump part is reusable. Each time container 160 is empty it can be replaced by a new, filled container. Container 160 with mouthpiece 161 is coupled to pump part 159 by forming a bayonet closure.

FIG. 17a shows pump part 159. Pump part 159 comprises a handle 168 provided with two recesses 169 in which can be received a shaft 170 which can be suspended pivotally in two recesses (one visible) 171 in pump body 172. All components can be manufactured by injection moulding. Pump body 172 is provided on the top side with a slot 173 in which protrusions 162 can be placed and rotated in order to make a bayonet closure.

Pump part 159 further comprises a resilient means 174 and a closing ring 175. Ring 175 comes to lie on the outer end 176 around tube 177. Tube 177 is provided with three edges 179 which are received in grooves 180 arranged in tube 178 of pump body 172. Ring 175 is hereby non-rotatable. Tube 177 comes to lie inside tube 178. Body 172 is connected with a bracket 181 to the fixed world, for instance a wall.

FIG. 18 shows a partially cut-away view along arrow XVIII in FIG. 16. Shown is how container 160 is placed with mouthpiece 161 and spout 164 in tube 178 according to arrow 182. In order to close the bayonet fitting the protrusions 162 will be aligned with slot 173. The arms 183 of plunger 163 will hereby have a fixed position relative to pump body 172. Arms 183 will engage and be guided by flange 184 arranged on the inner wall of tube 177. Arms 183 will move first along flange 184, whereby the arm comes to lie under flange 184. With further movement as according to arrow 182 and subsequent rotation according to arrow 185, arm 183 will be moved through flange 184 to the extreme position as shown in FIG. 9b. Container 160 with dispensing unit is only now made ready for use after placing in the reusable pump part 159.

Movement of handle 168 has the result that closing ring 175 will move upward relative to the fixed part 172, whereby arms 183 are moved upward so that the plunger will dispense a first volume through its delivery channel. The plunger and the system for dispensing are embodied the same as in the third embodiment.

FIG. 19 shows the assembly of a fifth embodiment. Container 200 is a supply of soap. Container 200 is provided on an outer end with an external screw thread 201 onto which a cap 202 can be screwed.

A sliding scraper 203 is arranged in container 200. The sliding scraper is for instance of a flexible material such as a rubber. The sliding scraper fits closely onto the inner side walls of container 200. When container 200 is emptied via cap 202, the sliding scraper moves along the side walls whereby no or little soap is left in the container.

Cap 202 is further provided with a closing part 204. This part is broken during use. The closing part is arranged on cap 202 over opening 205. In opening 205 can be arranged a protruding part which passes through closing part 204. During fitting of the dispensing part, the device as described below, onto the container the upper end (as shown in the representation of FIG. 19) of part 209 will protrude through opening 205. The upper end will press part 204 free when container 200 is coupled to the dispensing device. Part 204 remains attached to the top side of part 209 by means of a clamping. Part 204 is of a flexible material with a determined inner diameter. The upper end of part 209 has a determined outer diameter, for instance a scarcely larger outer diameter. This results in a clamping of ring 204 on the upper end of part 209. The fluid can flow by means of the openings in the side of the upper end of part 209 of the container through opening 205 to the dispensing device.

The device according to the fifth embodiment comprises a body constructed from two parts 206,207. Parts 206 and 207 can be formed by injection moulding. The parts are provided with a mutually engaging system, the couplings 208 of which can be seen on part 206. The parts can be mutually connected, whereby the dispensing mechanism as described below is accommodated/enclosed in the central part of the body. In another embodiment a screw connection is possible. A snap/click connection is also possible.

The dispensing mechanism comprises a part 209 which is fixedly connected to body 206/207 and has a central axis 210. A large flange 211 is arranged in receiving space 212 of parts 206/207, whereby part 209 is fixedly positioned.

A flexible ring 213 is arranged around the neck 214. This outer end is also provided with a cylindrical part 215 provided with two protrusions 216. Cylinder 215 can be placed in opening 205 of cap 202 and can be rotated a quarter-turn so that the cylinder with protrusions 216 remains received in the opening. Opening 205 is provided in known manner with stops which make such a connecting mechanism possible. During use the container is in fact rotated a quarter-turn relative to cylinder 215. Ring 213 provides for a leakage-free connection of part 209 on cap 202 of container 200.

The dispensing mechanism further comprises a spring mechanism which is arranged around neck 217 of part 209 and which comprises a helical spring 218 and a spring bush 219. Using a handle 220 connected to housing 206/207 for pivoting as according to arrow 222 about shaft 221, spring bush 219 can be moved relative to housing 206/207 as according to arrow 223 counter to the force of spring 218. In the position of use the arrow 223 is directed vertically.

When the handle is moved along 222, displacing means/plunger 224 will likewise move as according to arrow 223. Plunger 224 is received in the cavity on the inner side of neck 217. Plunger 224 is guided by means of protrusions 225 in the vertical slots 226 of neck 217.

As is more readily visible in the section of FIG. 20, the plunger is provided with a dispensing spout 227 which has an increasingly smaller inner diameter in downward direction. Soap is dispensed via this spout.

A ring 229 of a flexible material is arranged on edge 228 of the plunger. The ring lies against inner wall 230. With movement according to arrow 223 the ring 229 will connect in leakage-free manner to this inner wall 230.

Ring 229 is arranged between plunger end 228 and a dispensing means 231, which is connected for instance by means of a screw connection to plunger 224. FIG. 20 shows an embodiment with a cam/recess 232.

Ring 229 is a scraper. It has a cylindrical edge with a specific thin tapering form. This edge is “sharp”. The edge stands sharply upward in the mounted situation, has a clear angle and no rounding. This is important for the use of “filled” soaps. This prevents in new and inventive manner that the filling, for instance a fine sand, can be pressed between the seal, whereby leakage could be caused. This effect is greatly reduced when the shown scraper with an acute angle is used. This embodiment can be applied in the other embodiments and can also be applied in prior art dispensing devices. A dispensing device with such a scraper functions better. This measure can form the basis of a divisional application relating to a general dispensing device in which such a scraper is applied.

The toadstool-like part 231 forms a disc under which a ring 233 is arranged in the situation shown in FIG. 20. During the downward directed movement of spring bush 219 and plunger 224 as according to arrow 223 the ring 234 will lie against the edge of disc 233, whereby the passage between the space below disc 233 and above disc 233 is closed.

When disc 233 moves downward the volume in space 235 increases. The space will be filled with soap from container 200 via opening 205 through cylinder 215 as shown with arrow 236. The soap 236 herein passes through the one-way valve 237 arranged on the inner side of neck 217 on protrusion 238, which is arranged around the passage 239 formed by cylinder 215.

According to an embodiment a distributor 240 is arranged in passage 239. The valve 237 connects clampingly to the upright protrusion 238. Because valve 237 is obtained by injection moulding with a plastic, the valve can engage clampingly on protrusion 238.

Valve 237 prevents a flow of fluid in a direction opposite to arrow 236.

When plunger 224 is moved upward as according to arrow 223, space 235 will be reduced in size. Plunger 224 will move upward when handle 220 is moved as according to arrow 222.

Plunger 224 is provided with side parts 225 which move in slot 226 in neck 217. The length of side parts 225 and of slot 226 determine the dispensing volume. Plungers 224 for different applications can be provided by adapting the slot length A to the desired dosage. According to an alternative, different necks 217 of modified length B of slot 226 can be provided.

The space 235 has two inlets/outlets for a fluid present in the space. Outlet 239 is however blocked by one-way valve 237. When the plunger moves upward, ring 234 will not connect to edge 233, whereby soap present in space 235 can leave space 235 as according to arrow 241 via the plunger and through spout 227. When the plunger moves considerably upward, ring 229 will move ring 234 upward along the inner wall 230 of cylinder 217.

The wall mounting 250 is further shown in FIGS. 19 and 20. This part is fixed to the wall by means of three screw holes. The dispensing device is arranged at an angle (between 30 and 80°, for instance about 60°) on the protrusions 252 of wall holder 250 by having the openings 251 on the rear of parts 206 and 207 engage thereon.

By pivoting or rotating the dispensing device the snap on wall mounting 250 falls over the tongue at bottom left of the dispensing device and the mounting of the dispensing device on the wall mounting is locked. Openings 251 form the cylindrical chambers over which the rotation takes place. Should it be wished to once again release the dispensing device from the wall mounting, it is then possible via the slot in the wall holder under the snap to push back the snap with a screwdriver or the like, and subsequently perform the rotation upward in opposite direction and take out the dispensing device.

1. Device for metered dispensing of a pasty mass, such as viscous soap, comprising a housing provided with
connecting means for connecting the device to an opening of a container for pasty mass,
a dispensing chamber for the pasty mass,
a connecting channel which connects the connecting means to the dispensing chamber,
a first valve means which is arranged in the connecting channel and which closes feed from the connecting channel to the connecting means,
a delivery channel connected to the dispensing chamber for the purpose of delivering a dispensed quantity of pasty mass,
a displacing means which is movable in the dispensing chamber and which has a first position in which the dispensing chamber has a first volume and which is movable counter to a spring force of a spring means to a second position in which the dispensing chamber has a second, smaller volume,
a second valve means which is adapted to close the connection from the delivery channel to the dispensing chamber when the displacing means moves from the second position to the first position, wherein the second valve means comprises a movable body arranged around the displacing means.

2. Device as claimed in claim 1, characterized in that the body lies against a wall of the dispensing chamber.

3. Device as claimed in claim 1, characterized in that close to the 5 connection of the delivery channel to the dispensing chamber is arranged a valve disc which protrudes substantially centrally in the dispensing chamber, wherein the valve disc has at least one flange protruding in the direction of a side wall of the dispensing chamber.

4. Device as claimed in claim 2, characterized in that the valve disc is arranged on the displacing means.

5. Device as claimed in claim 4, characterized in that the second valve means is formed by the valve disc and the body in the form of a closing ring which can close a passage from the dispensing space to the delivery channel formed between the flange of the valve disc and the side wall of the dispensing chamber.

6. Device as claimed in claim 1, characterized in that the body is arranged lying freely around a part of the displacing means.

7. Device as claimed in claim 1, characterized in that the dispensing chamber is cylindrical.

8. Device as claimed in claim 1, characterized in that the device is provided with adjusting means for the dispensing.

9. Device as claimed in claim 8, characterized in that the adjusting means are arranged on the displacing means.

10. Device as claimed in claim 9, characterized in that the adjusting means are formed by the valve disc.

11. Device as claimed in claim 8, characterized in that the adjusting means are formed by at least one protrusion 225 of a determined length, this at least one protrusion being arranged along the periphery of the displacing means and being movable in corresponding slots of a determined length.

12. Device as claimed in claim 1, characterized in that a handle is connected pivotally to the housing and to the displacing means.

13. Device as claimed in claim 1, characterized in that the first valve means is formed by a ball which is arranged in the connecting channel and which closes a passage with a bias in the direction of the connecting means.

14. Device as claimed in claim 13, characterized in that a spring engages on the ball with a determined bias.

15. Device as claimed in claim 1, characterized in that the device comprises the container, wherein the container has a receiving space for pasty mass, and that a piston is movable in the preferably cylindrical receiving space.

16. Device as claimed in claim 15, characterized in that the piston is movable at least in the direction of the opening of the container.

17. Device as claimed in claim 1, characterized in that the container is a can and that the housing is provided with a disc which substantially protrudes in a central part of the container with at least one flange protruding in the direction of a side wall of the container.

18. Device as claimed in claim 17, characterized in that the disc is a diaphragm.

19. Device as claimed in claim 1, characterized in that the device is provided with engaging means for attaching the device to a fixed object.

20. Device as claimed in claim 1, characterized in that the device is adapted to be oriented with the container on a top side, the delivery channel on a bottom side and the dispensing chamber therebetween.
